(19) United States
(12) Patent Application Publication
(10) Pub. No.: US 2010/0177285 A1
(43) Pub. Date: Jul. 15, 2010

(54) Optical scanning device, optical scanning image display device and retinal scanning display

(75) Inventor: Masahiro Sakakibara, Toyokawa-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/659,743

(22) Filed: Mar. 19, 2010

Related U.S. Application Data
(63) Continuation-in-part of application No. PCT/JP2008/067401, filed on Sep. 26, 2008.

(30) Foreign Application Priority Data
Sep. 28, 2007 (JP) 2007-256840

(51) Int. Cl. G03B 21/20; G02B 26/10

(52) U.S. Cl. 353/85; 359/197.1; 359/202.1; 359/204.2

(57) ABSTRACT

An optical scanning device includes a light source which radiates light of intensity corresponding to an electric current supplied to the light source, an optical scanning part which is capable of scanning the light radiated from the light source in the predetermined direction, and a light source drive part which supplies a bias current of a predetermined current value to the light source and sequentially supplies an electric current corresponding to an image signal to the light source. The light source drive part stops or reduces the supply of the bias current to the light source during at least a predetermined period of an invalid scanning period where an image display is not performed.

### CROSS-REFERENCE TO RELATED APPLICATIONS

The present application is a Continuation-in-Part of International Application PCT/JP2008/067401 filed on Sep. 26, 2008, which claims the benefits of Japanese Patent Application No. 2007-256840 filed on Sep. 28, 2007.

### BACKGROUND

1. Field

The present invention relates to an optical scanning device, an optical scanning image display device, and a retinal scanning type image display device.

2. Description of the Related Art

Conventionally, there has been known an image display device such as an optical scanning image display device which scans an optical flux generated based on an image signal on a projection surface on which an image is projected and displays the image.

As such an image display device, there has been known an image display device having an optical scanning device which includes a light source, an optical scanning part and a light source drive part. The light source radiates an optical flux having intensity corresponding to a supplied electric current. The optical scanning part scans an optical flux radiated from the light source on a projection surface. The light source drive part sequentially supplies an amount of electric current corresponding to an image signal to the light source. Further, the optical scanning device enhances the responsiveness of the light source by supplying a bias current to the light source from the light source drive part.

### SUMMARY OF THE INVENTION

However, in the above-mentioned conventional optical scanning device, a bias current is steadily supplied to the light source and hence, there arises a drawback that the power consumption is increased. Particularly, when such an optical scanning device is applied to a portable-type image display device such as a retinal scanning type image display device, power which the portable-type image display device can carry is limited and hence, it is desirable to suppress the power consumption as much as possible.

Accordingly, it is an object of the present invention to provide an optical scanning device, an optical scanning image display device, and a retinal scanning display which can reduce the power consumption with simple constitution while enhancing responsiveness of a light source by a bias current.

To overcome the above-mentioned drawbacks, according to one aspect of the present invention, there is provided an optical scanning device which includes a light source which radiates light of intensity corresponding to an electric current supplied to the light source, an optical scanning part which is capable of scanning the light radiated from the light source in the predetermined direction, and a light source drive part which supplies a bias current of a predetermined current value to the light source and sequentially supplies an electric current corresponding to an image signal to the light source. The light source drive part stops or reduces the supply of the bias current to the light source during at least a predetermined period of an invalid scanning period where an image display is not performed.

To overcome the previously-mentioned drawback, according to another aspect of the present invention, there is provided an optical scanning image display device which includes the above-mentioned optical scanning device. This optical scanning image display device can perform a projection display of an image on a projection surface by scanning light modulated corresponding to an image signal two-dimensionally using the optical scanning device.

To overcome the previously-mentioned drawback, according to still another aspect of the present invention, there is provided a retinal scanning display which includes the above-mentioned optical scanning device. This retinal scanning display projects an image on at least a retina of one of user's eyes and displays the image on the retina by scanning light modulated corresponding to an image signal two-dimensionally using the optical scanning device.

### BRIEF EXPLANATION OF DRAWINGS

FIG. 1 is an explanatory view showing an optical scanning device according to one embodiment of the present invention;

FIG. 2A and FIG. 2B are views for explaining a scanning mode of an optical flux by an optical scanning part of the optical scanning device;

FIG. 3 is a view showing the relationship between a drive current and a light emission amount in a light source;

FIG. 4 is a view showing one example of an equivalent circuit of the light source;

FIG. 5 is a view for explaining a rise characteristic of the light source;

FIG. 6 and FIG. 7 are views for explaining the supply starting and supply stop of a bias current in the vertical direction;

FIG. 8 and FIG. 9 are views for explaining the supply starting and supply stop of the bias current in the horizontal direction; and

FIG. 10 is a graph showing a mode in which a threshold current value of the light source is changed corresponding to an ambient temperature.

### DESCRIPTION

Hereinafter, preferred embodiments of the present invention are explained in conjunction with attached drawings. The explanation is made by taking a retinal scanning display which includes an optical scanning device according to one embodiment of the present invention as an example. This retinal scanning display scans a laser beam (hereinafter referred to as an “optical flux”) modulated corresponding to an image signal by using an optical scanning device, and projects an image on at least one retina of a user so as to display the image. The application field of the present invention is not limited to the retinal scanning display. That is, the present invention is applicable to other image display devices which display an image by scanning an optical flux such as an optical scanning image display device which performs a projection display of an image on a projection surface by scanning an optical flux modulated corresponding to an image signal by the optical scanning display.

### 1. Embodiment

### 1.1. Schematic Constitution of Optical Scanning Device

First of all, the schematic constitution of an optical scanning device which a retinal scanning display according to this embodiment includes is explained in conjunction with drawings.

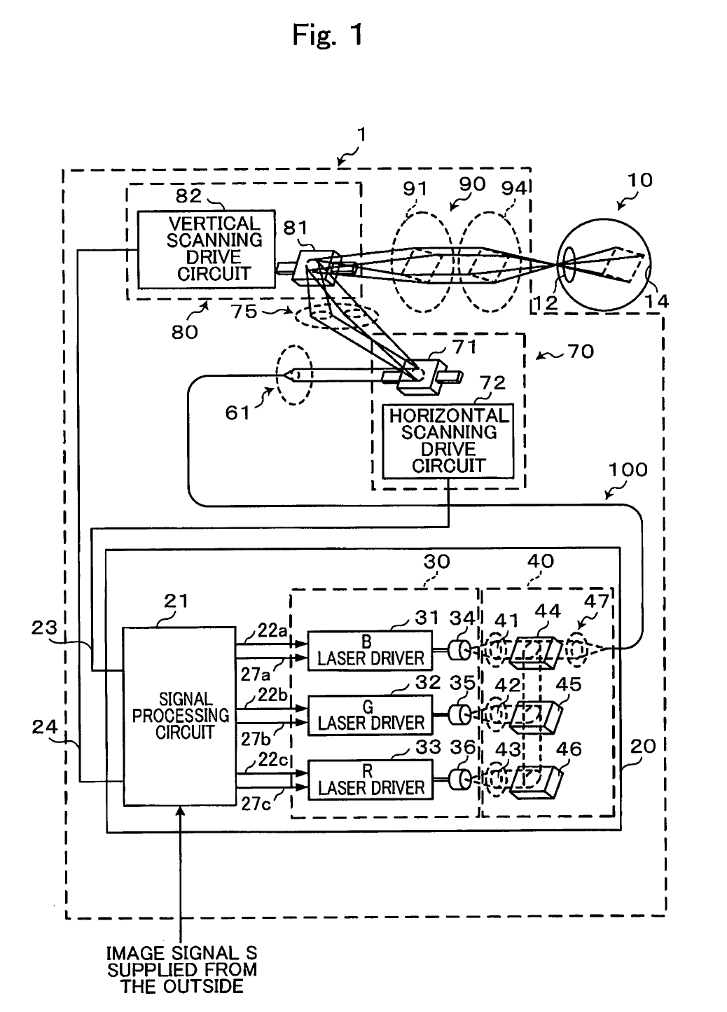

As shown in FIG. 1, the optical scanning device 1 includes an optical flux generator 20 which generates an optical flux whose intensity is modulated corresponding to an image signal S supplied from the outside and radiates the optical flux. The optical scanning device 1 also includes, between the optical flux generator 20 and a viewer's eye 10, an optical scanning part which two-dimensionally scans an optical flux radiated from a light source described later which is provided to the optical flux generator 20. The optical scanning part includes a collimation optical system 61, a horizontal scanning part 70 (constituting one example of a high-speed scanning part), a vertical scanning part 80 (constituting one example of a low-speed scanning part), a first relay optical system 75, and a second relay optical system 90. An optical flux generated by and radiated from the optical flux generator 20 is incident on the collimation optical system 61 via an optical fiber 100, and the collimation optical system 61 collimates the optical flux. The horizontal scanning part 70 scans the optical flux collimated by the collimation optical system 61 in a horizontal direction at a relatively high speed. The vertical scanning part 80 scans the optical flux scanned in the horizontal direction using the horizontal scanning part 70 in the vertical direction at a relatively low speed. The second relay optical system 90 allows the optical flux scanned in the horizontal direction as well as in the vertical direction two-dimensionally (hereinafter, referred to as “scanned optical flux”) to be incident on a pupil 12. The first relay optical system 75 is provided between the horizontal scanning part 70 and the vertical scanning part 80.

As shown in FIG. 1, the optical flux generator 20 includes a signal processing circuit 21 which generates respective signals or the like which constitute components for displaying an image. The signal processing circuit 21 outputs a horizontal synchronizing signal 23 used in the horizontal scanning part 70 and a vertical synchronizing signal 24 used in the vertical scanning part 80 respectively. Further, the signal processing circuit 21 generates respective image signals 22a to 22c of blue (B), green (G) and red (R) and outputs these image signals 22a to 22c based on an image signal S supplied from the outside. Further, the signal processing circuit 21 generates bias current supply signals 27a to 27c for supplying bias current to respective lasers 34, 35, 36 described later which constitute light sources, and outputs the bias current supply signals 27a to 27c to respective laser drivers 31, 32, 33 described later. The bias current supply signals 27a to 27c may be outputted from the signal processing circuit 21 in a superposed manner with the respective image signals 22a to 22c of blue (B), green (G) and red (R).

Further, the optical flux generator 20 includes a light source part 30 and a light synthesizing part 40. The light source part 30 forms optical fluxes from three image signals (B, G, R) 22a to 22c outputted from the signal processing circuit 21 respectively. The light synthesizing part 40 generates an arbitrary optical flux by combining these three optical fluxes generated by the light source part 30 into one optical flux.

The light source part 30 includes, as a plurality of light sources corresponding to three primary colors, a B laser 34 which generates a blue optical flux, a G laser 35 which generates a green optical flux and an R laser 36 which generates a red optical flux. These B laser 34, G laser 35, R laser 36 function as light sources which radiate optical fluxes having intensity corresponding to a value of supplied current (drive current). The B laser 34, the G laser 35 and the R laser 36 may be constituted of a semiconductor laser or a solid-state laser having a harmonics generation mechanism, for example. When the respective lasers are formed of the semiconductor laser, intensity of the optical flux can be modulated by directly modulating a drive current. On the other hand, when the respective lasers are formed of the solid laser, it is necessary to modulate intensity of the optical flux by providing an external modulator to every laser.

The light source part 30 also includes a B laser driver 31 which drives the B laser 34, a G laser driver 32 which drives the G laser 35 and an R laser driver 33 which drives the R laser 36. These B laser driver 31, G laser driver 32 and R laser driver 33 constitutes light source drive parts which drive the B laser 34, the G laser 35 and the R laser 36 as follows respectively. That is, the laser drivers 31, 32, 33, based on the bias current supply signals 27a to 27c outputted from the signal processing circuit 21, supply bias currents to the B laser 34, the G laser 35 and the R laser 36 respectively. The laser drivers 31, 32, 33 also, during a valid scanning period where the optical scanning part scans an optical flux for displaying an image, sequentially supply an amount of electric current corresponding to the image signal S (hereinafter, referred to as “drive current”) to the B laser driver 31, the G laser driver 32 and the R laser for every pixel.

The light synthesizing part 40 includes collimation optical systems 41, 42, 43, dichroic mirrors 44, 45, 46, and a coupling optical system 47. The collimation optical systems 41, 42, 43 are provided for collimating the optical fluxes incident from the light source part 30. The dichroic mirrors 44, 45, 46 synthesize the optical fluxes collimated by the collimation optical systems 41, 42, 43. The coupling optical system 47 guides a synthesized optical flux to the optical fiber 100. The optical fluxes radiated from the respective lasers 34, 35, 36, after being collimated by the collimation optical systems 41, 42, 43 respectively, are respectively incident on the dichroic mirrors 44, 45, 46. Thereafter, using these dichroic mirrors 44, 45, 46, the respective optical fluxes are reflected on the dichroic mirrors 44, 45, 46 or are allowed to pass through the dichroic mirrors 44, 45, 46 selectively corresponding to wavelengths thereof, arrive at the coupling optical system 47, are converged by the coupling optical system 47, and are outputted to the optical fiber 100.

The horizontal scanning part 70 and the vertical scanning part 80, to allow the optical fluxes incident thereon from the optical fiber 100 to be projectable as an image, scan the optical fluxes incident from the optical fiber 100 in the horizontal direction as well as in the vertical direction so as to form scanned optical fluxes.

The horizontal scanning part 70 includes a scanning element 71 and a horizontal scanning drive circuit 72. The scanning element 71 includes a reflection surface for scanning the optical fluxes in the horizontal direction. The horizontal scanning drive circuit 72 generates a drive signal for swinging the reflection surface of the scanning element 71 based on the horizontal synchronizing signal 23 outputted from the signal processing circuit 21. The vertical scanning part 80 includes a scanning element 81 and a vertical scanning drive circuit 82. The scanning element 81 includes a reflection surface for scanning the optical fluxes in the vertical direction. The vertical scanning drive circuit 82 drives the scanning element 81 based on the vertical synchronizing signal 24 outputted from the signal processing circuit 21. A Galvano mirror or the like, for example, may be used as the scanning element 71 and the scanning element 81. Further, the scanning element 71 and the scanning element 81 may be driven by any drive method such as piezoelectric driving, electromagnetic driving or electrostatic driving provided that the reflection surface can be swung (rotated) so as to scan the optical fluxes.

Further, as described above, the optical scanning device 1 includes the first relay optical system 75 which relays the optical fluxes between the horizontal scanning part 70 and the vertical scanning part 80. The optical fluxes which are scanned in the horizontal direction by the scanning element 71 pass through the first relay optical system 75, are scanned by the scanning element 81 in the vertical direction, and are radiated to the second relay optical system 90 as the two-dimensionally-scanned optical fluxes.

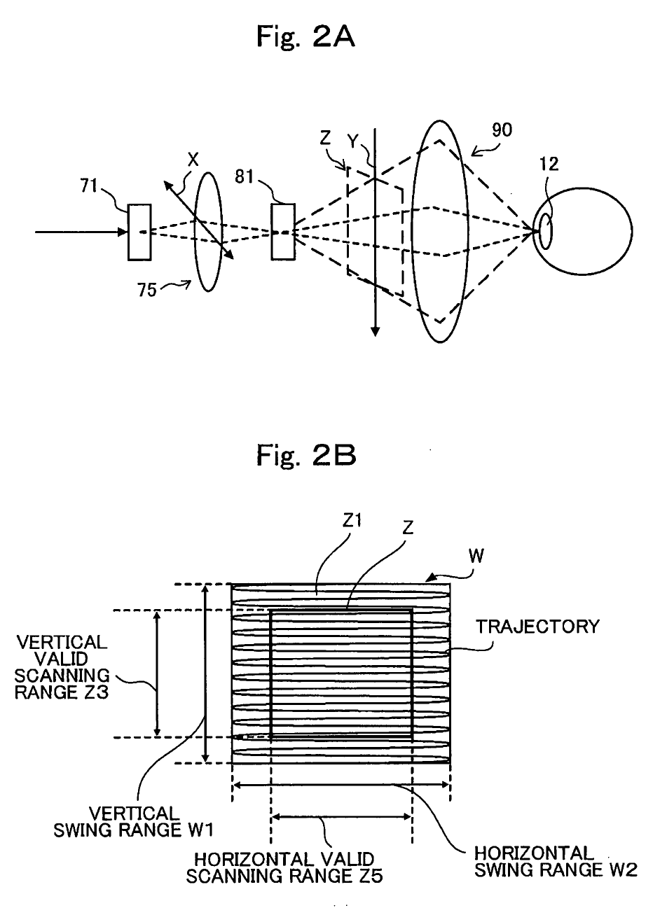

That is, as shown in FIG. 2A, the scanning element 71 which is swingable at the relatively high-speed is swung by the horizontal scanning drive circuit 72 and scans an incident optical flux in a horizontal direction X in a reciprocating manner. Then, the scanned optical fluxes which are scanned in the horizontal direction by the scanning element 71 are incident on the vertical scanning part 80 via the first relay optical system 75. The scanning element 81 of the vertical scanning part 80 is swung in a sawtooth waveform by the vertical scanning drive circuit 82 such that the incident optical fluxes are scanned in a vertical direction Y. Then, the scanned optical fluxes within the valid scanning range Z which are scanned in the vertical direction by the scanning element 81 are incident on the pupil 12 of the user via the second relay optical system 90.

FIG. 2B shows the relationship between a swing range W (a vertical swing range W1 and a horizontal swing range W2) of the scanning element 71 and the scanning element 81 and the valid scanning range Z (a vertical valid scanning range Z3 and a horizontal valid scanning range Z5). Within the swing range W of the scanning element 71 and the scanning element 81, by allowing the optical flux generator 20 to radiate the optical fluxes at timing within a range Z (hereinafter, referred to as “valid scanning range Z”), the optical fluxes are scanned in the valid scanning range Z by the horizontal scanning part 70 and the vertical scanning part 80. Due to such scanning, the optical flux for one frame is scanned. This scanning is repeated for every one frame of an image. FIG. 2B shows, assuming that the optical flux is constantly radiated from the optical flux generator 20, an imaginary trajectory of the optical flux scanned by the horizontal scanning part 70 and the vertical scanning part 80. In the following explanation, ranges Z1 obtained by excluding the valid scanning range Z from the swing range W are referred to as “invalid scanning ranges Z1” (see FIG. 2B).

As shown in FIG. 1, the second relay optical system 90 includes lens systems 91, 94 having positive refracting power. Using the lens system 91, center lines of the scanned optical fluxes radiated from the vertical scanning part 80 are arranged parallel to each other, and the optical fluxes are respectively formed into converged optical fluxes. Then, using the lens system 94, the converged optical fluxes are arranged substantially parallel to each other and, then, are converted so that the center lines of the optical fluxes are converged on the pupil 12 of the viewer. In this manner, by allowing the optical flux to be incident on the pupil 12 of the viewer thus projecting an image on the retina 14, a virtual image can be visually observed in front of the pupil 12 of the viewer's eye 10.

Here, in this embodiment, the optical flux incident from the optical fiber 100 is scanned in the horizontal direction by the horizontal scanning part 70 and, thereafter, is scanned in the vertical direction by the vertical scanning part 80. However, the arrangement of the horizontal scanning part 70 and the arrangement of the vertical scanning part 80 may be exchanged so that the optical flux is scanned in the vertical direction by the vertical scanning part 80 and, thereafter, is scanned in the horizontal direction by the horizontal scanning part 70.

### 1.2. Driving Method of Laser

Next, a driving method of the respective lasers 34, 35, 36 according to this embodiment is explained.

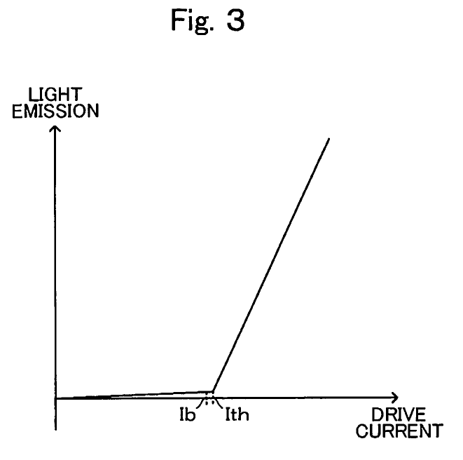

Firstly, the characteristics of the respective lasers 34, 35, 36 are explained in conjunction with FIG. 3. In FIG. 3, a light emission amount is taken on an axis of ordinates, and a drive current value is taken on an axis of abscissas.

As shown in FIG. 3, the respective lasers 34, 35, 36 have a characteristic that a light emission amount of the laser sharply rises when a drive current which exceeds a unique threshold current Ith is supplied to the laser, while the light emission amount of the laser is hardly changed when the drive current is held equal to or below the threshold current Ith. Accordingly, in the optical scanning device 1 according to this embodiment, the drive current of equal to or more than the threshold current Ith is supplied to the respective lasers 34, 35, 36 so as to allow the respective lasers 34, 35, 36 to radiate optical fluxes for displaying an image.

Each laser 34, 35, 36 is formed of a semiconductor laser or the like as described previously and hence, contains a capacitance component therein. Accordingly, a delay time is generated from a point of time that the supply of a drive current of the threshold current Ith or more is started to a point of time that the light emission is started.

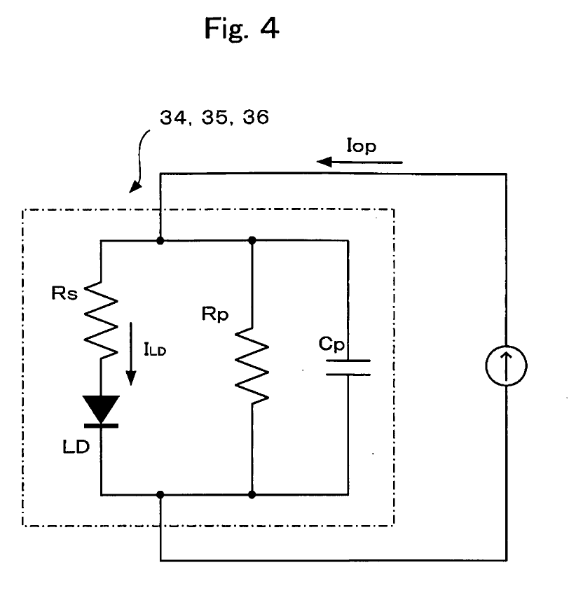

As shown in FIG. 4, an electric circuit of each laser 34, 35, 36 is considered equivalent to a circuit where a parasitic resistance Rs is connected to a laser diode LD in series, and a parasitic capacitance Cp and a parasitic capacitance Rp are connected to such serial connection in parallel.

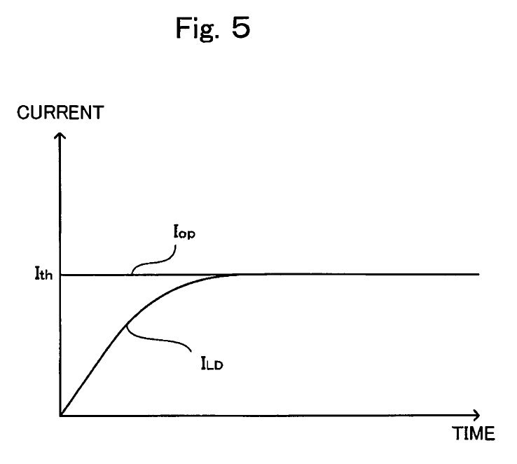

Accordingly, as shown in FIG. 5, when a drive current Iop is changed from 0 to the threshold current Ith at a point of time t=0, a part of the drive current Iop is consumed for charging the parasitic capacitance Cp. Therefore, an effective current I_{LD} which is actually used for light emission rises with a time constant Cp·Rs (assuming Rp>>Rs which usually holds) and hence, the drive current Iop takes time to reach a desired current value. In this manner, a delay is generated in each laser 34, 35, 36 with respect to time from the supply of the drive current Iop to each laser 34, 35, 36 to starting of light emission.

Conventionally, for suppressing this delay of light emission, each laser is configured such that a bias current Ib (usually taking a value slightly smaller than the threshold current Ith) is supplied to each laser thus enhancing responsiveness of each laser.

However, the supply of such a bias current Ib increases the power consumption of the optical scanning device 1.

Under such circumstances, the optical scanning device 1 according to this embodiment is configured such that the supply of the bias current Ib to each laser 34, 35, 36 from each laser driver 31, 32, 33 is stopped or reduced at least within a predetermined range of the invalid scanning range Z1 (see FIG. 2B). That is, each laser driver 31, 32, 33 stops or reduces the supply of the bias current Ib to each laser 34, 35, 36 at least within a predetermined period of an invalid scanning period where an image display is not performed.

In this manner, by stopping or reducing the supply of the bias current to the respective lasers 34, 35, 36 within a predetermined period, it is possible to reduce the power consumption of the optical scanning device 1 while enhancing the responsiveness during image display. Here, the reduction of the supply of the bias current Ib can be acquired by supplying an electric current which is ½ of the bias current Ib, for example. In the explanation made hereinafter, the stop of the supply of the bias current Ib includes not only the stop of the supply of the bias current Ib but also the reduction of the supply of the bias current Ib.

Next, the specific constitution and the manner of operation for starting or stopping the supply of the bias current Ib is explained in conjunction with the drawings.

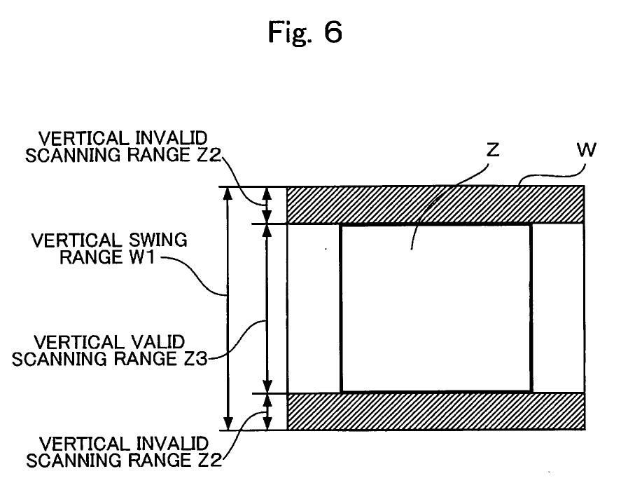

As shown in FIG. 6, in a range Z2 in the vertical direction in which a valid scanning range Z is not included out of a vertical swing range W1 by the scanning element 81 (hereinafter referred to as “vertical invalid scanning range Z2”), an optical flux is not radiated from the optical flux generator 20 so that an image is not displayed. Further, to enhance the responsiveness of the respective lasers 34, 35 and 36, it is sufficient to supply the bias current Ib to the respective lasers 34, 35 and 36 from a point of time that scanning is shifted to a vertical valid scanning range Z3 in which a valid scanning range Z is included out of a vertical swing range W1.

Accordingly, particularly, the optical scanning device 1 of this embodiment is configured to stop the supply of the bias current Ib to the respective lasers 34, 35 and 36 from the respective drivers 31, 32 and 33 in the vertical invalid scanning range Z2 indicated by hatching in FIG. 6. Due to such a constitution, the power consumption can be reduced.

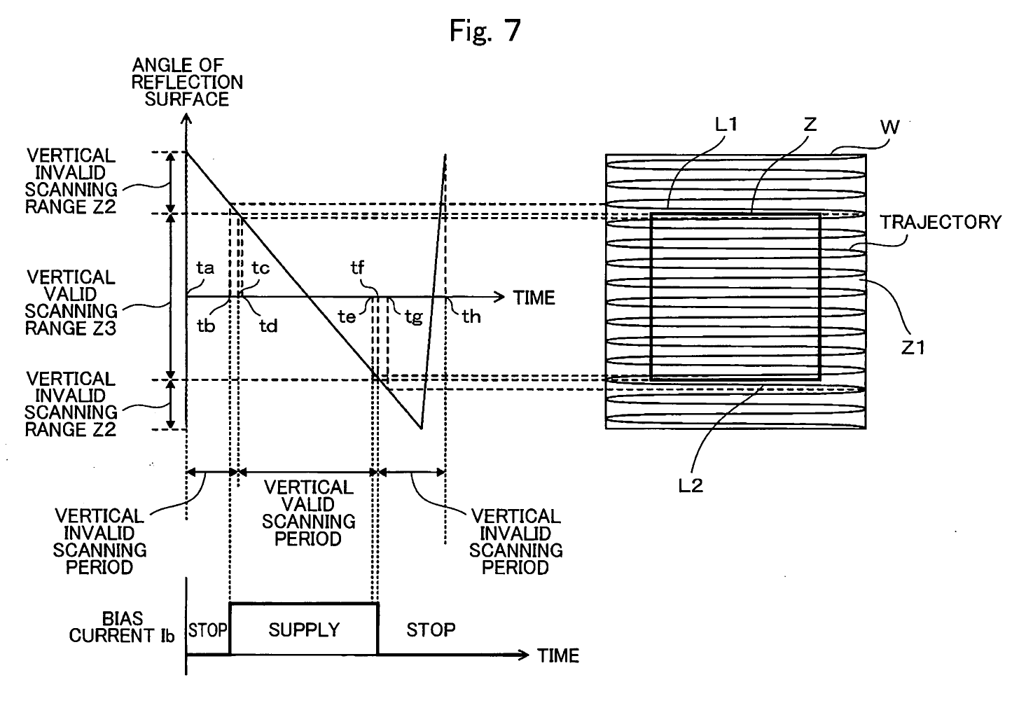

Here, the relationship between the vertical scanning by the scanning element 81 and a period during which the bias current Ib is supplied is explained in conjunction with FIG. 7. A left upper part of FIG. 7 shows the relationship between an angle of a reflection surface of the scanning element 81 and time. A left lower part of FIG. 7 shows starting and stopping of the supply of the bias current Ib and time. A right upper part of FIG. 7 shows the relationship between the valid scanning range Z and the invalid scanning range Z1 in the same manner as in FIG. 2B.

As shown in FIG. 7, the respective drivers 31, 32, 33 start the supply of the bias current Ib to the respective lasers 34, 35, 36 within a predetermined time (timing of tc to tb) before a point of time that the scanning by the vertical scanning part 80 is shifted to the vertical valid scanning period in which an image display is performed from the vertical invalid scanning period. Thereafter, the respective drivers 31, 32, 33 stop the supply of the bias current Ib to the light source immediately after a point of time that the scanning by the vertical scanning part 80 is shifted to the invalid scanning period from the valid scanning period (timing of tf to tg).

That is, the respective laser drivers 31, 32, 33 start the supply of the bias current Ib to the respective lasers 34, 35, 36 when a scanning taken by the vertical scanning part 80 falls on a scanning line L1 in the horizontal direction immediately before a point of time that the scanning is shifted to the vertical valid scanning range Z3 from the vertical invalid scanning range Z2. Then, the respective laser drivers 31, 32, 33 stops the supply of the bias current Ib to the respective lasers 34, 35, 36 when the scanning taken by the vertical scanning part 80 falls on a first scanning line L2 in the horizontal direction due to shifting of the scanning to the vertical invalid scanning range Z2 from the vertical valid scanning range Z3.

In this manner, the supply of the bias current Ib is started within a predetermined time before a point of time that the scanning is shifted to the vertical valid scanning period and hence, at a point of time that the vertical scanning is shifted to the valid scanning range Z, bias current Ib is supplied to the respective lasers 34, 35, 36 whereby the respective lasers 34, 35, 36 are in a highly responsive state. Accordingly, it is possible to surely prevent lowering of image quality of a display image attributed to delay of light emission and, at the same time, the power consumption during the vertical invalid scanning period can be reduced.

Further, in scanning 1 frame of an image, it is sufficient to perform a start control and a stop control (or a reduction control) of the supply of the bias current Ib one time respectively and hence, it is possible to reduce the power consumption without making the processing complicated.

Timing at which the supply of the bias current Ib to the respective lasers 34, 35, 36 is started may be set such that the bias current Ib is supplied to the respective lasers 34, 35, 36 at the point of time the scanning is shifted to the valid scanning range Z so that the respective lasers 34, 35, 36 assume a highly responsive state.

The equivalent circuit of the respective lasers 34, 35, 36 has the constitution shown in FIG. 4 as described above, wherein a rise time constant Δt of an effective current I_{LD} is expressed by a following formula (1).

Δt=−CP·Rs (1)

Here, assume Rp>>Rs which usually holds.

Accordingly, taking unique rise time constants which the respective lasers 34, 35, 36 possess into consideration, it is sufficient to start the supply of the bias current Ib to the respective lasers 34, 35, 36 within Δt before a point of time that the vertical scanning is shifted to the valid scanning period. Due to such an operation, the power consumption can be further reduced.

By stopping the supply of the bias current Ib to the respective lasers 34, 35, 36 immediately after a point of time that the vertical scanning is shifted to the invalid scanning range Z1 from the valid scanning range Z (timing te), the power consumption can be further reduced.

As described above, according to the optical scanning device 1 of this embodiment, the respective laser drivers 31, 32, 33 which constitute light source drive parts stop the supply of the bias current to the respective lasers 34, 35, 36 which constitute the light sources when the scanning by the scanning part falls within at least a predetermined time in the invalid scanning period. Accordingly, the power consumption during the predetermined period in the invalid scanning period where a user does not visually recognize an image can be reduced.

### 2. Second Embodiment

Next, another embodiment of the optical scanning device according to the present invention is explained. In the above-mentioned first embodiment, the supply of the bias current Ib to the respective lasers 34, 35, 36 which constitute the light sources is started or stopped depending on whether or not the vertical scanning performed by the vertical scanning part 80 falls in the vertical invalid scanning range Z2 or in the vertical valid scanning range Z3. On the other hand, in this second embodiment, a range in which the supply of the bias current Ib is stopped is further expanded. That is, in this second embodiment, the supply of the bias current Ib to the respective lasers 34, 35, 36 which constitute the light sources is started or stopped corresponding to horizontal scanning performed by the horizontal scanning part 70. An optical scanning device 1 of this second embodiment has the substantially same constitution as the optical scanning device 1 of the first embodiment, while the second embodiment partially differs from the first embodiment with respect to processing or the like. Accordingly, this embodiment is explained hereinafter particularly with respect to parts which make this embodiment different from the first embodiment.

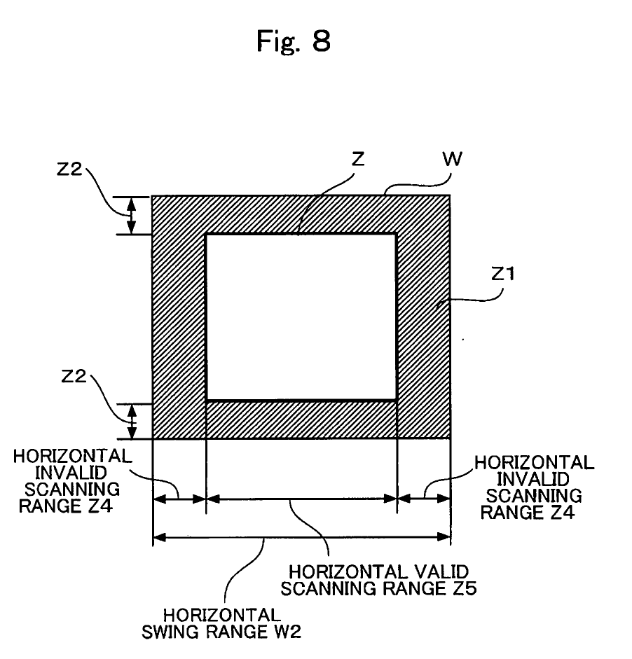

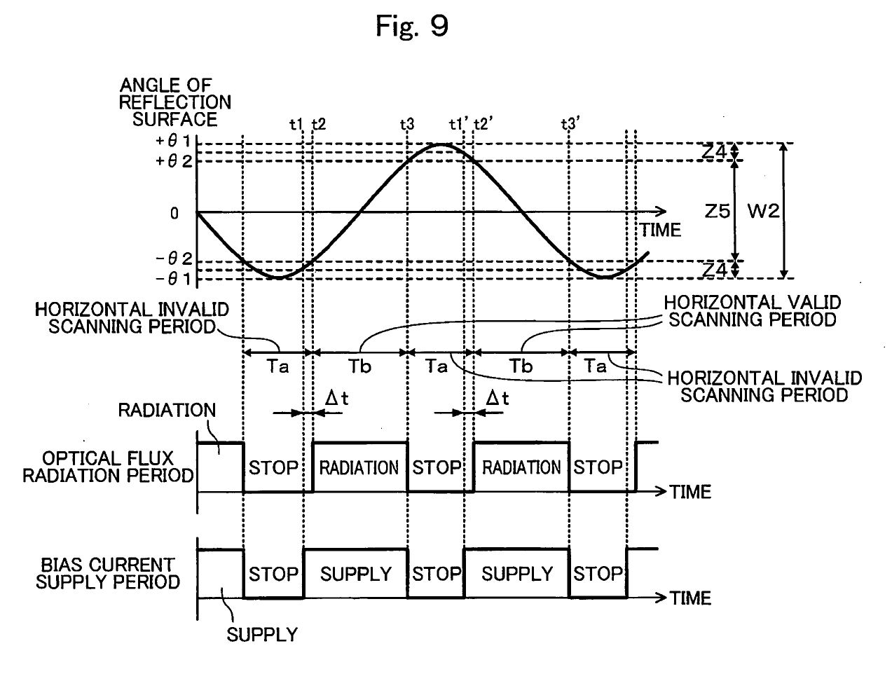

Hereinafter, the optical scanning device according to the second embodiment is explained specifically in conjunction with FIG. 8 and FIG. 9.

As shown in FIG. 8, in an invalid scanning range Z1 (region indicated by hatching in FIG. 8) which is a range formed by excluding a valid scanning range Z from a horizontal swing range W2 of the scanning element 71, an optical flux is not radiated from the optical flux generator 20 so that an image is not displayed. Accordingly, it is sufficient so long as the respective lasers 34, 35, 36 assume a highly responsive state at a point of time that scanning is shifted to the valid scanning range Z. That is, in the most invalid scanning range Z1, it is unnecessary to preliminarily supply the bias current Ib to the respective lasers 34, 35, 36 to ensure the responsiveness of the respective lasers 34, 35, 36.

Accordingly, particularly, the optical scanning device of this embodiment is configured such that the bias current Ib is not supplied to the respective lasers 34, 35, 36 from the respective laser drivers 31, 32, 33 not only in a vertical invalid scanning ranges Z2 indicated by hatching in FIG. 8 but also in the most invalid scanning ranges Z1 indicated by hatching in FIG. 8.

That is, as shown in FIG. 8, out of the vertical valid scanning range Z3 (see FIG. 6), further in the horizontal invalid scanning ranges Z4, the bias current Ib is not supplied to the respective lasers 34, 35, 36 from the respective laser drivers 31, 32, 33. Due to such an operation, the power consumption can be further reduced.

However, it is necessary for the respective lasers 34, 35, 36 to assume a highly responsive state at a point of time that the horizontal scanning is shifted to the valid scanning range Z from the horizontal invalid scanning range Z4. Accordingly, it is necessary to start the supply of the bias current Ib to the respective lasers 34, 35, 36 within a predetermined time before a point of time that the horizontal scanning is shifted to the vertical scanning range Z. The predetermined period must be longer than time Δt corresponding to the rise time constants of the respective lasers 34, 35, 36 explained in conjunction with the first embodiment (see formula (1)).

Here, the relationship between the horizontal scanning performed by the scanning element 71 and a period during which the bias current Ib is supplied is explained in conjunction with FIG. 9. An upper part of FIG. 9 shows the relationship between an angle of a reflection surface of the scanning element 71 and time, a middle part of the FIG. 9 shows the relationship between start and stopping of radiation of an optical flux by the optical flux generator 20 and time, and a lower part of FIG. 9 shows the relationship between start and stopping of the supply of the bias current Ib and time.

As shown in FIG. 9, the reflection surface of the scanning element 71 is swung by the horizontal scanning drive circuit 72 within an angle range (horizontal swing range W2) of +θ1 to −θ1 by taking a predetermined position as a reference (0 degree). Further, the scanning element 71 is configured such that an optical flux from the optical flux generator 20 is radiated from the reflection surface of the scanning element 71 within a range of ±θ2 (horizontal valid scanning range Z5).

Further, in this embodiment, as shown in FIG. 9, the respective laser drivers 31, 32, 33 start the supply of the bias current Ib to the respective lasers 34, 35, 36 within a predetermined time Δt before a point of time that the scanning performed by the horizontal scanning part 70 is shifted to a horizontal valid scanning period Tb during which an image display is performed from a horizontal invalid scanning period Ta. Then, the respective laser drivers 31, 32, 33 stops or reduces the supply of the bias current Ib to the respective lasers 34, 35, 36 when the scanning performed by the horizontal scanning part 70 is shifted to the horizontal invalid scanning period Ta from the horizontal valid scanning period Tb. Δt is time corresponding to rise time constants of the respective lasers 34, 35, 36, and is drawn from the formula (1) used in the first embodiment.

That is, the respective laser drivers 31, 32, 33 are configured to start, in a state where the scanning performed by the vertical scanning part 80 falls within the vertical valid scanning range Z3 (see FIG. 6), the supply of the bias current Ib to the respective lasers 34, 35, 36 within the predetermined time (Δt in FIG. 9) before a point of time that the scanning performed by the horizontal scanning part 70 is shifted to the horizontal valid scanning range Z5 from the horizontal invalid scanning range Z4 in the horizontal swing range W2 (timing indicated by “t1”, “t1′” in FIG. 9).

Further, the respective laser drivers 31, 32, 33 are configured to stop, in a state where the scanning performed by the vertical scanning part 80 falls within the vertical valid scanning range Z3, the supply of the bias current Ib to the respective lasers 34, 35, 36 when the scanning performed by the horizontal scanning part 70 is shifted to the horizontal invalid scanning range Z4 from the horizontal valid scanning range Z5.

Due to such operations, the bias current Ib is supplied to the respective lasers 34, 35, 36 in advance before a point of time that the scanning performed by the horizontal scanning part 70 falls within the horizontal valid scanning period Tb so that the respective lasers 34, 35, 36 assume a highly responsive state. Accordingly, it is possible to reduce the power consumption in the invalid scanning range Z1 while ensuring quality of a display image in the valid scanning range Z by obviating the delay of light emission of the respective lasers 34, 35, 36. Further, the supply of the bias current Ib is stopped when the scanning performed by the horizontal scanning part 70 is shifted to the horizontal invalid scanning period Ta from the horizontal valid scanning time Tb. Accordingly, the power consumption in the invalid scanning range Z1 can be reduced as much as possible.

Accordingly, during the period in which the scanning performed by the horizontal scanning part 70 falls within the valid scanning range Z, it is possible to reduce the power consumption as much as possible while ensuring the responsiveness of the respective lasers 34, 35, 36.

### 3. Other Embodiments

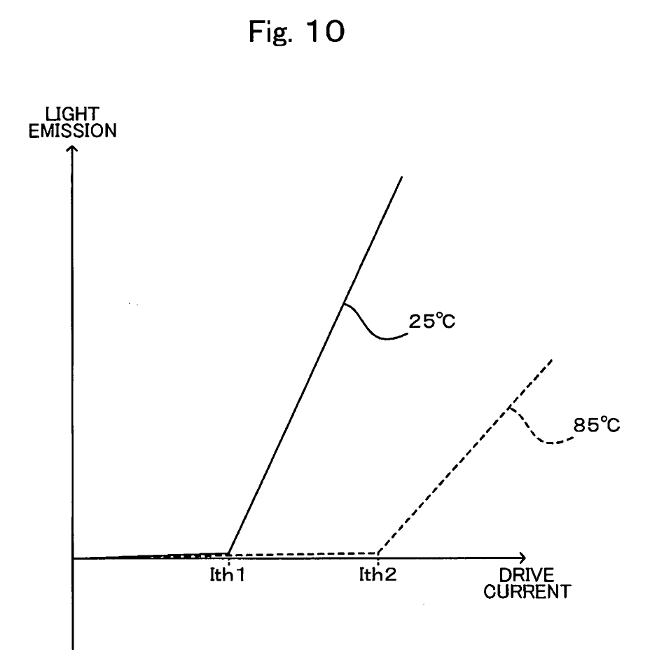

In the above-mentioned embodiments, the relationship between a drive current of the respective lasers 34, 35, 36 and an amount of emission light is shown in FIG. 3. This relationship is changed corresponding to an ambient temperature as shown in FIG. 10. In FIG. 10, in the same manner as FIG. 3, an amount of light emission is taken on an axis of ordinates, and a drive current value is taken on an axis of abscissas.

As shown in FIG. 10, in the respective lasers 34, 35, 36, a threshold current Ith2 at the high temperature of (85° C.) becomes larger than a threshold current Ith1 at a normal temperature (25° C.).

Accordingly, the optical scanning device includes a temperature measuring part (not shown in the drawing) which measures an ambient temperature of the B laser 34, the G laser 35, and the R laser 36 which constitute the light sources in the inside of the optical flux generator 20. The B laser driver 31, the G laser driver 32 and the R laser driver 33 may be configured to stop the supply of the bias current Ib to the B laser 34, the G laser 35 and the R laser 36 when the ambient temperature of the B laser 34, the G laser 35 and the R laser 36 measured by the temperature measuring part is higher than a predetermined temperature.

Due to such a constitution, it is possible to reduce the power consumption even when a drive current necessary for the light emission of the B laser 34, the G laser 35 and the R laser 36 is increased along with a rise of the ambient temperature.

Further, in the above-mentioned optical scanning devices of the first and second embodiments, the B laser driver 31, the G laser driver 32 and the R laser driver 33 may be configured to stop the supply of the bias current to at least one light source out of the B laser 34, the G laser 35 and the R laser 36 which constitute the plurality of light sources. In general, an operational voltage of the B laser is highest among operational voltages of the B laser 34, the G laser 35 and the R laser 36, and a drive current necessary for light emission of the B laser becomes largest. Accordingly, it is preferable to stop the supply of the bias current to the B laser 34 among these lasers.

In this manner, by stopping the supply of the bias current to the B laser 34 which requires the large drive current for light emission out of the B laser 34, the G laser 35 and the R laser 36 which constitute the plurality of light sources, it is sufficient to stop the supply of the bias current with respect to one light source. Accordingly, the power consumption can be more easily reduced compared to a case where the supply of the bias current is stopped with respect to all light sources.

Although several embodiments of the present invention have been explained in detail in conjunction with drawings heretofore, these embodiments are provided merely as examples, and the present invention can be carried out in other modes to which various modifications or improvements are applied based on knowledge of those who are skilled in the art. For example, it is needless to say that the optical scanning device to which the present invention is applied is also applicable to an optical scanning device which scans a laser beam in the inside of a laser printer.

What is claimed is:

1. An optical scanning device comprising:
a light source which is configured to radiate light of intensity corresponding to an electric current supplied to the light source;
an optical scanning part which is configured to be capable of scanning the light radiated from the light source in a predetermined direction; and
a light source drive part which is configured to supply a bias current of a predetermined current value to the light source, and is configured to sequentially supply an electric current corresponding to an image signal to the light source, wherein
the light source drive part is configured to stop or reduce the supply of the bias current to the light source during at least a predetermined period of an invalid scanning period where an image display is not performed.

2. An optical scanning device according to claim 1, wherein
the optical scanning part includes: a high-speed scanning part which is configured to scan light at a relatively high speed with respect to a first scanning direction; and a low-speed scanning part which is configured to scan light at a relatively low speed with respect to a second scanning direction which intersects or is orthogonal to the first scanning direction, and
the light source drive part is configured to start the supply of the bias current to the light source within a predetermined time before a point of time that scanning performed by the low-speed scanning part is shifted to a valid scanning period where an image display is performed from the invalid scanning period, and is configured to stop or reduce the supply of the bias current to the light source immediately after a point of time that the scanning performed by the low-speed scanning part is shifted to the invalid scanning period from the valid scanning period.

3. An optical scanning device according to claim 1, wherein
the optical scanning part includes: a high-speed scanning part which is configured to scan light at a relatively high speed with respect to a first scanning direction; and a low-speed scanning part which is configured to scan light at a relatively low speed with respect to a second scanning direction which intersects or is orthogonal to the first scanning direction, and
the light source drive part is configured to start the supply of the bias current to the light source within a predetermined time before a point of time that scanning performed by the high-speed scanning part is shifted to a valid scanning period where an image display is performed from the invalid scanning period, and is configured to stop or reduce the supply of the bias current to the light source when the scanning performed by the high-speed scanning part is shifted to the invalid scanning period from the valid scanning period.

4. An optical scanning device according to claim 3, wherein the predetermined time is decided corresponding to a unique rise time constant which the light source possesses.

5. An optical scanning device according to claim 1, further comprising a temperature measuring part which is configured to measure an ambient temperature of the light source, wherein
the light source drive part is configured to stop or reduce the supply of the bias current to the light source when an ambient temperature of the light source measured by the temperature measuring part is higher than a predetermined temperature.

6. An optical scanning device according to claim 1, wherein
the light source is constituted of a plurality of light sources which correspond to three primary colors respectively, and
the light source drive part is configured to stop or reduce the supply of the bias current with respect to at least one light source out of the plurality of light sources.

7. An optical scanning image display device comprising an optical scanning device and being configured to perform a projection display of an image on a projection surface by two-dimensionally scanning light modulated corresponding to an image signal using the optical scanning device, wherein
the optical scanning device includes:
a light source which is configured to radiate light of intensity corresponding to an electric current supplied to the light source;
an optical scanning part which is configured to be capable of scanning the light radiated from the light source in a predetermined direction; and
a light source drive part which is configured to supply a bias current of a predetermined current value to the light source, and is configured to sequentially supply an electric current corresponding to an image signal to the light source,
the light source drive part is configured to stop or reduce the supply of the bias current to the light source during at least a predetermined period of an invalid scanning period where an image display is not performed.

8. A retinal scanning type display device comprising an optical scanning device and being configured to project an image on at least a retina of a user by two-dimensionally scanning light modulated corresponding to an image signal using the optical scanning device, wherein
the optical scanning device includes:
a light source which is configured to radiate light of intensity corresponding to an electric current supplied to the light source;
an optical scanning part which is configured to be capable of scanning the light radiated from the light source in a predetermined direction; and
a light source drive part which is configured to supply a bias current of a predetermined current value to the light source, and is configured to sequentially supply an electric current corresponding to an image signal to the light source,
the light source drive part is configured to stop or reduce the supply of the bias current to the light source during at least a predetermined period of an invalid scanning period where an image display is not performed.
